(19) United States
(12) Patent Application Publication
(10) Pub. No.: US 2014/0067833 A1
(43) Pub. Date: Mar. 6, 2014

(54) USER-BASED CONTENT FILTERING

(71) Applicants: Dipraj Nandi, (US); Gunjan Jain, (US)

(72) Inventors: Dipraj Nandi, (US); Gunjan Jain, (US)

(73) Assignee: Microsoft Corporation, Redmond, WA (US)

(21) Appl. No.: 13/598,422

(22) Filed: Aug. 29, 2012

(51) Int. Cl. G06F 17/30

(52) U.S. Cl. 707/754; 707/E17.059; 707/E17.032

(57) ABSTRACT

This document describes techniques of user-based content filtering. The techniques receive content of a selected category from one or more sources, filter the content received from the one or more sources based on predefined settings for the user, and present at least some of the filtered content in a portion of a single user interface. By so doing, users can quickly and easily access filtered content via the single user interface.

### BACKGROUND

Users typically access different types of content from a variety of sources. Portals and applications are often designed to permit a user to access a particular category of content. Accordingly, each portal or application is often designed with a specific set of features for accessing the particular category of content. While the specific set of features of a respective portal or application permit a user to access a particular category of content, these features can prevent the user from accessing other categories of content via the portal or application. Thus, in order to access multiple categories of content, a user often initiates multiple instances of a browser interface (e.g., windows or tabs) and/or different applications to do so. For example, a user may initiate an instance of a browser and navigate to an email portal to access email. If the user also desired to access a micro media feed, however, another instance of the browser's user interface (or another application) would be initiated to facilitate access of this different category of content.

Initiating multiple instances of the browser interface or different applications, however, can be cumbersome and/or inefficient. To switch between each type of category of content, the user often navigates through the multiple instances to find a browser interface or application corresponding to the desired category. Furthermore, executing software associated with the multiple instances of the browser interface or different applications may consume additional memory, processing, or power resources resulting in computing inefficiencies.

### SUMMARY

This document describes techniques of user-based content filtering. These techniques may enable content of a selected category to be received from one or more sources of content. The content may then be filtered based on predefined settings for a user. The filtered content can then be presented in a portion of a single user interface. By so doing, the user can quickly and easily access the filtered content via the single user interface.

This summary is provided to introduce simplified concepts for user-based content filtering, which is further described below in the Detailed Description. This summary is not intended to identify essential features of the claimed subject matter, nor is it intended for use in determining the scope of the claimed subject matter.

### BRIEF DESCRIPTION OF THE DRAWINGS

Embodiments of techniques and apparatuses enabling user-based content filtering are described with reference to the following drawings. The same numbers are used throughout the drawings to reference like features and components:

FIG. 1 illustrates an example environment in which techniques of user-based content filtering can be implemented.

FIG. 2 illustrates example content sources for implementing user-based content filtering.

FIG. 3 is illustrates an example user interface presenting filtered content of a user.

FIG. 4 illustrates an example user interface presenting filtered content of a user's social network contacts.

FIG. 5 illustrates an example user interface presenting filtered content recommended by other members of social networks.

FIG. 6 illustrates an example method of filtering received content of a selected category.

FIG. 7 illustrates an example user interface presenting filtered content of a user selected category or content source.

FIG. 8 illustrates an example method of filtering content received from selected content sources.

FIG. 9 illustrates an example device in which techniques of user-based content filtering can be performed.

### DETAILED DESCRIPTION

### Overview

This document describes techniques and apparatuses enabling user-based content filtering. The techniques filter content received from one or more sources based on predefined settings for a user. The techniques then present the filtered content in a portion of a single user interface. By so doing, the user can quickly and easily access the filtered content via the single user interface.

Consider, for example, the user attempting to access email and a micro media feed as mentioned above. Assume that the user has three new emails and four unread micro media feeds. The techniques can receive email content and micro media feed content of the user from separate respective sources in the cloud. The content received from the respective email and micro media feed sources can then be filtered based on predefined user setting (e.g., social networking information) and presented to the user in a single user interface. Here, the user is presented with the three new emails and four unread media feeds in a single tabbed portion of a user interface. Furthermore, the techniques may also enable the user to access (e.g., via tabbing, voice command, or gesture input) content in which the user's social contacts have interest, or content recommended by other members of social networks.

These techniques can be used well in advance of presenting filtered content to a user, though techniques may not require advance preparation. Instead, the techniques may operate nearly instantaneously on initiation or interaction with an application or software module providing a user interface for the presentation of filtered content.

This is but one example of how techniques and/or apparatuses enabling user-based content filtering can be implemented. Techniques and/or apparatuses that enable user-based content filtering are referred to herein separately or in conjunction as the “techniques” as permitted by the context. This document now turns to an example environment in which the techniques can be embodied, followed by various example methods for performing the techniques, after which an example device in which the techniques may be embodied is described.

Example Environment

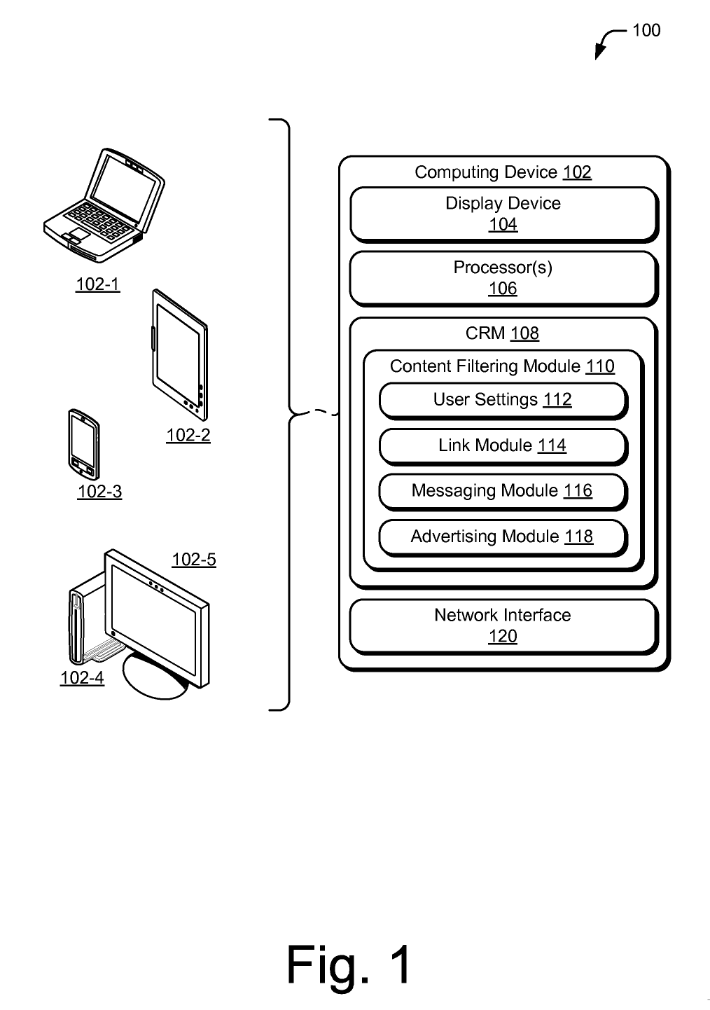

FIG. 1 is an illustration of an example environment 100 in which techniques of user-based content filtering can be implemented. Environment 100 includes a computing device 102, which may be implemented and/or embodied in any suitable configuration. Computing device 102 can be one or a combination of various devices, here illustrated with four examples: a laptop computer 102-1, a tablet computer 102-2, a smartphone 102-3, and a set-top box 102-4 associated with display device 102-5, though other computing devices and systems, such as internet-protocol enabled televisions (IP TVs), netbooks, gaming consoles, and cellular phones, may also be used.

Computing device 102 includes display device 104 (either integral or separate), one or more processors 106, and computer-readable storage media 108 (CRM 108). Display device 104 presents and enables interaction with various user interfaces of computing device 102, such as a user interface of an operation system or application. Processor 106 executes code or instructions stored by CRM 108 to implement various functionalities of computing device 102. For example, an operating system (or other applications) of computing device 102 may be implemented when processor 106 executes operating system code (not shown) stored by CRM 108.

CRM 108 includes content user-based filtering module 110 (content filtering module 110) and other software of computing device 102, which is not illustrated here for visual brevity. Content filtering module 110 includes, or has access to, user settings 112, link module 114, messaging module 116, and advertising module 118. These components, either alone or in combination, are able implement techniques of user-based content filtering.

Content filtering module 110 enables content to be filtered prior to, or during, presentation of the content to a user. The filtered content may also be filtered into one or more subsets of filtered content. In some cases, the content is filtered based on user settings 112, which may include predefined user settings associated with filtering or presenting content. In such cases, these predefined user settings may be based on social networking information associated with the user. For example, social networking information may identify social network contacts of a user, relationships with these social contacts, and/or interests of members of the social network. Accordingly, the content may be filtered into subsets of filtered content based on the social networking information.

Link module 114 manages sources of content, such as content from websites, email servers, really simple syndication (RSS) feeds, social networks, and the like. Link module 114 may receive user selection of content sources or may receive a uniform resource locator (URL) thereof. Messaging module 116 provides messaging capabilities, which may be combined with other aspects of user-based content filtering as will be described below in greater detail.

Advertising module 118 manages the presentation of and/or interaction with advertisements. These advertisements may be presented or configured in association with the presentation of filtered content. Alternately or additionally, advertising module may track user interaction with non-advertising content (e.g., clickstreams or clickpaths). In some cases, interaction with the advertisements may be reported to advertising partners or other affiliates, such as third-party content providers.

These and other capabilities of the above-described components, as well as ways in which entities of FIG. 1 act and interact, are set forth in greater detail below. These entities may be further divided, combined, and so on. The entities of environment 100 of FIG. 1 are but one example of the many possible environments in which the described techniques may be employed.

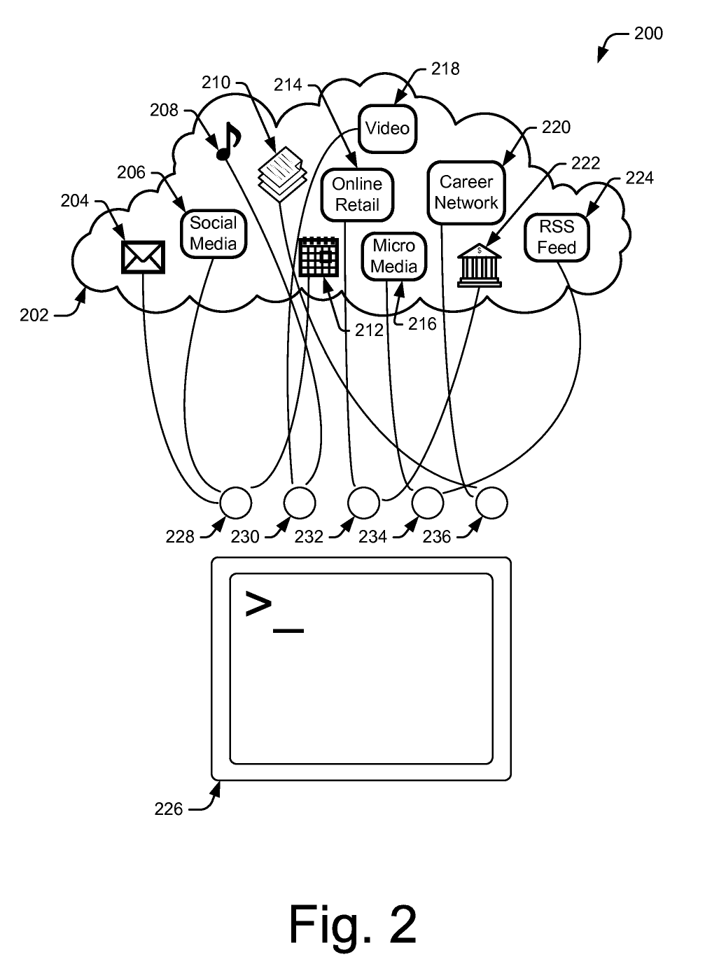

FIG. 2 illustrates example content sources for implementing user-based content filtering at 200. Cloud 202 may include any number and/or type of content sources (or content providers). These content sources may include websites, RSS feeds, micro media feeds, email servers, social networks, and the like. Content may be received in any suitable form, such as text, hyperlinks, images, videos, music, or any combination thereof. In some cases, content may be received as a continuous feed of content from a content source. In such cases, credentials of a user may be passed or proxied to a content source by content filtering module 110.

In this particular example, cloud 202 includes a variety of content sources, such as email source 204, social media source 206, music source 208, cloud document source 210, and calendar source 212. These content sources may be personalized and/or unique to a respective user. For example, email source 204, cloud document source 210, and calendar source 212, may all include personal information of a user. This personal information may be accessed once credentials (e.g., a username and password) are provided to a content source.

Cloud 202 also includes online retail source 214, micro media source 216, web video source 218, career network source 220, financial source 222, and RSS feed source 224. As described above, these content sources may be personalized to a user or may provide generalized content to multiple users. For example, online retail source 214 may provide a feed of notices for upcoming sales to all entities subscribing to online retail source 214. Other sources of content contemplated, but not shown, may include sources for photos, images, corporate information, travel, geography, gaming, and the like.

Generally, content from content sources 204-224 is presented via user interface 226. Alternately or additionally, content sources 204-224, or content feeds thereof, may be categorized to enable more-efficient access of the content. In this particular example, these categories include home category 228, video category 230, shopping category 232, news category 234, and corporate category 236. Categorization of content sources may be logical or customized by a user, as will be described in greater detail below. Here, content sources 204-224 are logically categorized as illustrated in FIG. 2. For example, home category 228 includes content feeds from email source 204, social media source 206, and calendar source 212.

Other categories contemplated, but not shown, include music, cooking, travel, automotive, technology, and the like. For example, a travel category may present or enable access to travel sites, feeds on travel deals, feeds for travel related shopping, or travelogue posts. Alternately or additionally, a health category (e.g., cooking or fitness categories) may present feeds for recipes, fitness tips and lessons, workout regiments/tracking, or personal fitness results.

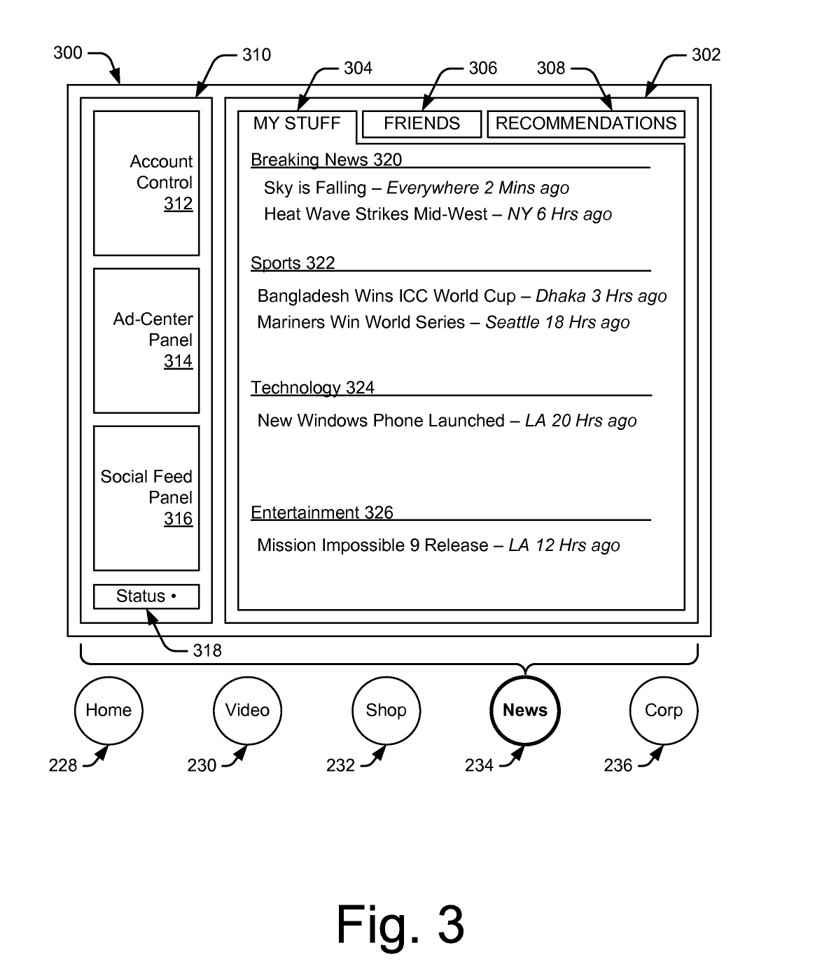

With regard to the example user interface 226 and content sources 204-224 of FIG. 2, consider a detailed example of user interface 300 in FIG. 3. Generally, user interface 300 is associated with a content-filtering application executed on, or by, computing device 102. Alternately or additionally, user interface 300 may be associated with a website or web-based content filtering application that a user accesses via a browser. User interface 300 includes content presentation portion 302 for presenting filtered content. Content presentation portion includes visually-perceptible filtering controls, which in this particular example, are illustrated as control tabs 304, 306, and 308. Control tabs enable a user to navigate or toggle through filtered subsets of content presented within user interface 300.

As illustrated in FIG. 3, control tabs 304, 306, and 308 enable a user to switch between subsets of filtered content for the user (“My Stuff”), filtered content of the user's social networking contacts (“Friends”), or recommendations from members of one or more social networks (“Recommendations”) respectively. Although illustrated as control tabs, filtering controls of user interface 300 may be implemented as any suitable control, such as visual sliders, visual buttons, keyboard shortcuts, keyboard hotkeys, or touch input gestures (e.g., single or multi-touch touchscreen input).

User interface 300 also includes panel portion 310 for presentation of additional user interface elements. Panel portion 310 includes account control panel 312, ad-center panel 314, and social feed panel 316. Account control panel 312 enables a user to configure various aspects of user interface 300 and settings for reward accounts or content sources. For example, a user may enter multiple sets of credentials for different content sources via account control panel 312. Once these sets of credentials are stored by content filtering module 110 in user settings 112, content filtering module 110 can then receive content from the respective content sources on behalf of the user.

Account control panel 312 may also enable a user to create, modify, delete, and/or combine custom content categories. For example, a user may create a custom content category labeled “Outdoors” to present content associated with outdoor activities. The user may then, through account control panel 312, select content sources for this new category. Content sources may be added in various manners, such as selecting from URLs of a drop-down menu or by entering a URL for the content source.

Alternately or additionally, account control panel 312 enables a user to set or change service affiliations. Thus, the user may select a provider for search, email, cloud, or other services through user interface 300. Functionalities associated with account control panel 312 may be provided by various entities of content filtering module 110, such as link module 114.

Ad-center panel 314 presents advertisements to a user. In some cases, these advertisements may be customized or targeted for a particular viewer. In such cases, the customization or targeting may be based on any suitable information associated with the viewer, such as content viewed, search history, social networking information (e.g., indicated likes or interests), past online purchases, and so on. Features of ad-center panel 314 may be provided by advertising module 118 operating alone or in combination with other components of content filtering module 110.

Social feed panel 316 provides a live stream of social feeds from contacts of a user. These social feeds may be received from different social network or media feed sources. Social feed panel 316 may also enable a user interact with the social feeds, such as by sending replies to social network contacts or initiating a chat session with a contact. Features of social feed panel 316 may be provided by messaging module 116 operating alone or in combination with other components of content filtering module 110. Settings for social feed panel 316 may be configured via account control panel 312, such as adding, deleting, or modifying various social feeds. Panel portion 310 also includes status indicator 318 which indicates a user's online presence. Status indicator may also function as a status control allowing a user to set their online-status (e.g., online, idle, away, offline, or busy).

In this particular example, control tab 304 is selected causing content filtered specifically for the user (“My Stuff”) to be presented by content portion 302. Content portion 302 includes content sub-categories 320, 322, 324, and 326 which are labeled, by way of example only, as “Breaking News”, “Sports”, “Technology”, and “Entertainment” respectively. The sources of the content are the user's content sources for News category 234, which is also selected in the particular example. As illustrated in FIG. 3, user interface 300 permits a user to quickly access filtered content from one or more categories of content.

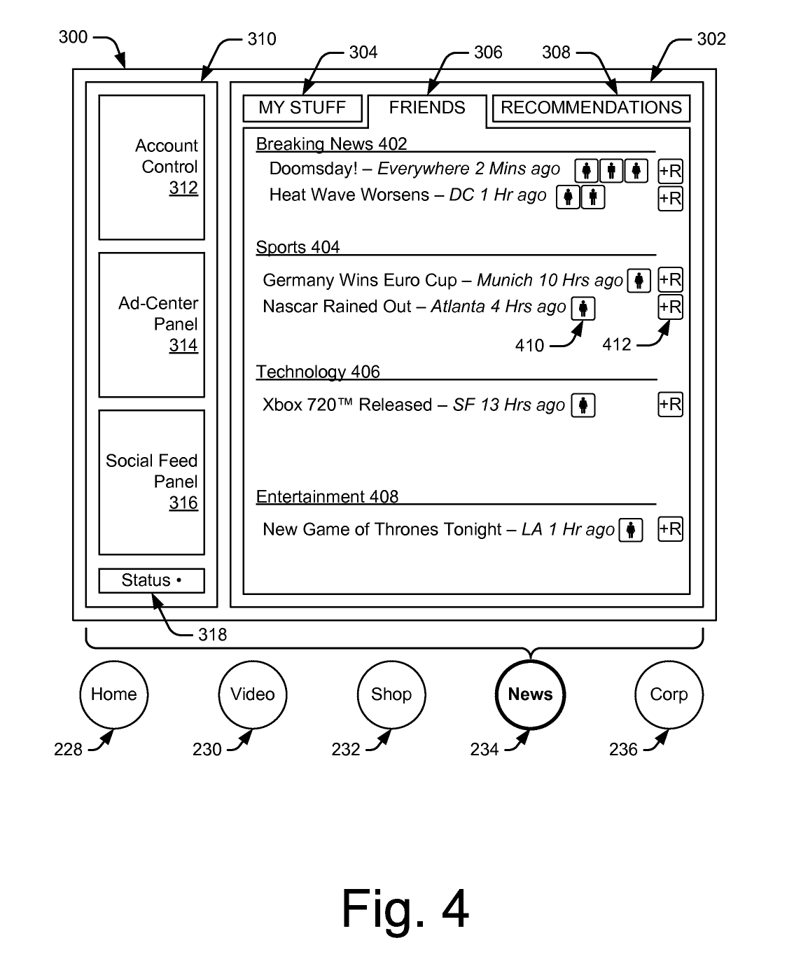

As another example, consider FIG. 4 which illustrates a subset of filtered content for a user's social network contacts being presented by user interface 300. In this particular example, control tab 306 is selected causing content filtered of a user's social network contacts (“Friends”) to be presented by content portion 302. Here, sub-categories 402, 404, 406, and 408 present feeds and content associated with the user's social networking contacts. The sources of the content are content sources for News category 234, which is also selected in this particular example. When presenting content of a user's social network contacts, contact identifier 410 and recommendation control 412 are displayed for one or more of the content entries. Contact identifier 410 indicates which of the user's social network contacts is interested in a particular content item. Alternately or additionally, the user can recommend the content item to other contacts in their social networks using recommendation control 412.

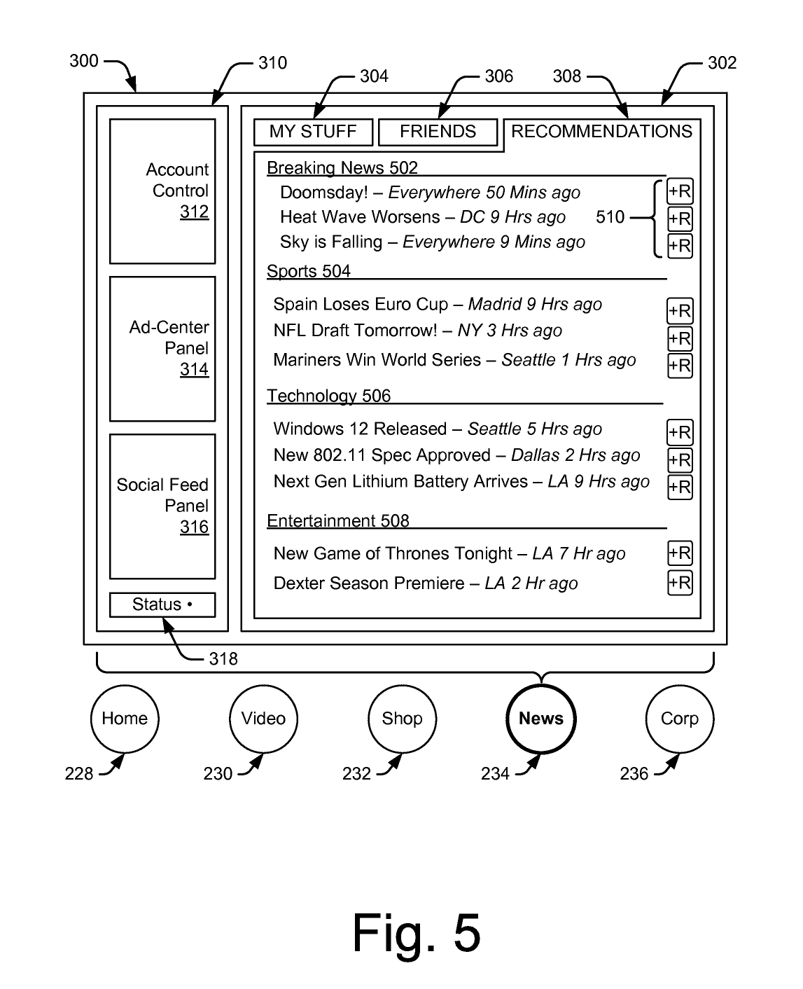

As another example, consider FIG. 5 which illustrates filtered content recommended by members of one or more social networks. In this particular example, control tab 308 is selected causing content filtered recommended by members of one or more social networks (“Recommendations”) to be presented by content portion 302. Here, sub-categories 502, 504, 506, and 508 present feeds and content associated with the members of the social networks. The sources of this content are also content sources for News category 234, which is selected in this particular example. When presenting recommended content, recommendation control(s) 510 are displayed for one or more of the content items. Recommendation control(s) 510 enable the user to recommend the content item to other contacts in their social networks.

These are but a few possible implementations of a user interface for presenting filtered content. The described portions or components of the user interface may be further combined and/or subdivided to implement one or more of the various aspects of the techniques described herein. Alternately or additionally, content filtering module 110 (or components thereof) may be implemented, in whole or part, by any suitable application capable of receiving and/or presenting content for user consumption.

Example Methods

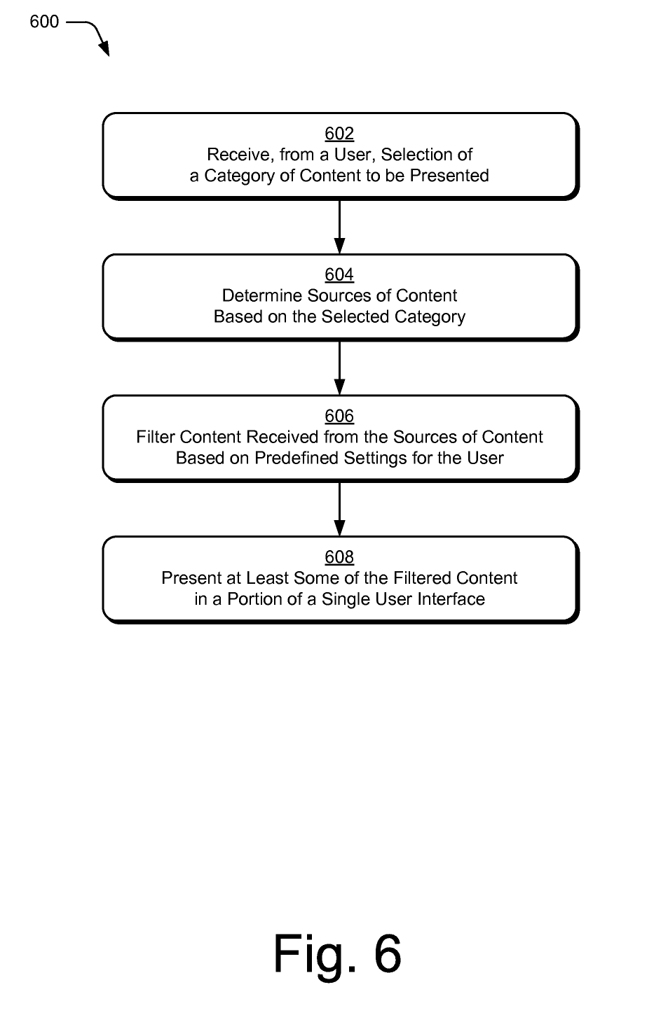

FIG. 6 depicts example method 600 of user-based content filtering. This and other methods described herein are shown as sets of blocks that specify operations performed but are not necessarily limited to the order shown for performing the operations by the respective blocks. In portions of the following discussion reference may be made to environment 100 of FIG. 1 and user interface elements detailed in FIGS. 3-5, and 7, reference to which is made for example only. The techniques are not limited to performance by one entity or multiple entities operating on one device.

Block 602 receives, from a user, selection of a category of content to be presented. The selection may be received in any suitable manner, such as through a visually-perceptible control, drop-down menu, gesture input, and so on. The category of content may be a logical or default category of content, such as news, sports, video, entertainment, music, photography, images, and so on. Alternately or additionally, the category of content may be a custom category defined by a user.

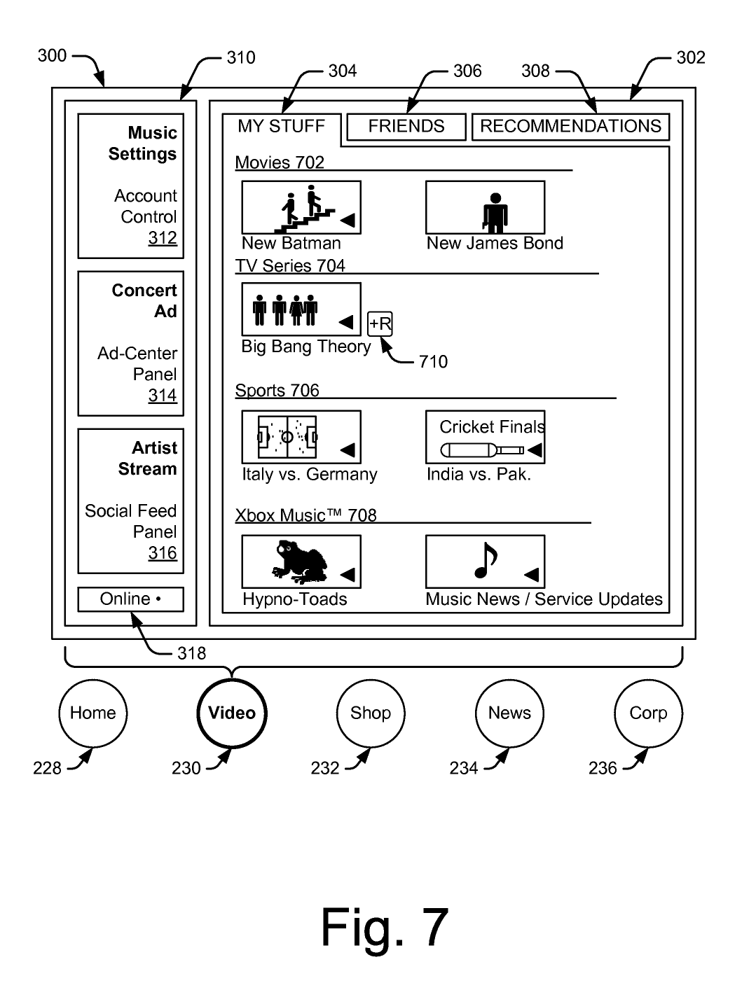

By way of example, consider user interface 300 in the context of FIG. 7, which illustrates filtered content of a user for video category 230. Here, content filtering module 110 receives the user's selection when the user clicks the visually-perceptible control (e.g., control button) for video category 230.

Block 604 determines sources of content based on the selected category of content. In some cases, a search engine provides potential sources of content from which one or more sources of content are chosen. The one or more sources may be chosen logically by popularity or relevance within the selected category. Alternately or additionally, a list of the potential content sources may be presented to the user for selection. A user may also enter a URL of a content source if a particular content source is not returned within the search results.

In the context of the present example, content filtering module 110 searches cloud 202 for sources of content based on the selection of video category 230. As illustrated in FIG. 2, content filtering module 110 discovers content feeds from music source 208 and web video source 218 for association with video category 230.

Block 606 filters content received from the sources of content based on predefined settings for the user. The predefined settings by which the content is filtered may be configured or selected by the user. In some cases, the content is filtered based on information associated with one or more social networks. This information may indicate personal interests, interests of social networking contacts, or recommendations of content by others in a respective social network. In such cases, the filtered content may be filtered into different subsets of filtered content that correspond to the predefined settings. Alternately or additionally, a user may set or configure the predefined settings (e.g., modifying social networking information) through a control panel of a user interface.

Credentials may also be transmitted to the sources of content prior to receiving the content. These credentials may be received from the user upon initial installation or set up of an application or account. Storing these credentials locally permits sources of content to be accessed subsequently without user interaction. This can optimize a user's experience of accessing content by reducing redundant or unnecessary user interactions.

Continuing the ongoing example, content filtering module 110 filters content received from music source 208 and web video source 218 based on user settings 112. Assume that user settings 112 include information received from a social network to which the user belongs. This information includes indicated interests in particular musical groups, venue locations, video content, types of music, and the like. These indicated interests are associated with not only the user, but social networking contacts of the user or other members of the social network that recommend video content. Here, content filtering module 110 filters the content into three subsets of filtered content: filtered content associated with the interests of the user, filtered content associated with interests of the user's social network contacts, and filtered content associated with recommendations of members of the social network.

Block 608 presents at least some of the filtered content in a portion of a single user interface. In some cases, the filtered content presented is one subset of filtered content selected from multiple subsets of filtered content. In such cases, the one subset of filtered content can be selected by default or by user interaction (e.g., via a filtering control tab). Optionally, presentation of the subset of filtered content may be partitioned into sub-categories. These sub-categories may be based on various attributes associated with the filtered content, such as temporal proximity, relevancy, geographical proximity, popularity, and so on. For example, sub-categories may include breaking news, local news, sports, trending new, entertainment, and the like.

Concluding the present example, content filtering module 110 presents filtered content of music source 208 and web video source 218 in content presentation portion 302 as illustrated by FIG. 7. Here, the subset of filtered content associated with the interests of the user is presented as control tab 304 is currently selected. Furthermore, the filtered content is partitioned into sub-categories 702, 704, 706, and 708, which are labeled “Movies”, “TV Series”, “Sports”, and “Xbox Music™” respectively. These sub-categories present video feeds from music source 208 (e.g., Hypno-Toads music video) and web video source 218 (e.g., New Batman video trailer). Additionally, the user may select to access a subset of filtered video content associated with their social-network contacts by selecting control tab 306, or to access video content recommend by other by selecting control tab 308.

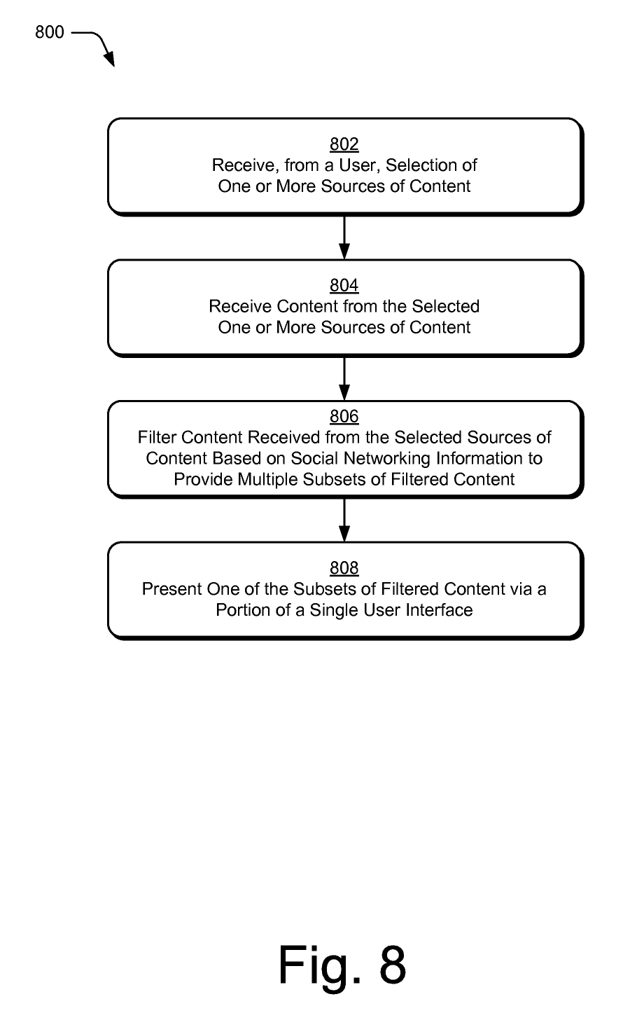

FIG. 8 depicts example method 800 for filtering content received from selected content sources.

Block 802 receives, from a user, selection of one or more sources of content. The sources of content may be selected from a drop down menu or by entry of a URL. For example, if a drop down menu does not contain a desired source of content, a user may enter a URL for the desired content source. The sources of content may be associated with a single or multiple categories of content. For instance, a user may wish to create a custom category of content which includes content or feeds of content from various sources (e.g., email, micro media, and calendar sources).

By way of example, again consider user interface 300 in the context of FIG. 7, which illustrates filtered content of a user for video category 230. Assume that a user has accessed account control panel 312 and selected to receive content from a music news website, micro media feed of the musical group (e.g. Hypno-Toads), and an online music service (e.g., Xbox Music™) Here, content filtering module 110 receives the user's selection of these content sources.

Block 804 receives content from the selected one or more sources of content. The sources of content may be any suitable type of source, such as a website, feed of content, RSS feed, videos, images, audio, and so on. In some cases, credentials may be sent to a source of content to authorize access of the content on behalf of a user. In such cases, credentials may be stored locally or in an online repository to facilitate unified access of content.

In the context of the present example, content filtering module 110 sends credentials to the online music service on behalf of the user. Assume here that accessing the other sources of content does not require credentialing. Filtering module 110 then receives content from the music news website, the micro media feed of the musical group, and the online music service.

Block 806 filters content received from the sources of content based on social networking information associated with the user. Filtering the content based on the social networking information provides multiple subsets of filtered content. The social networking information may indicate personal interests, interests of social networking contacts, or recommendations of content by others in a respective social network. Alternately or additionally, a user may set or configure settings associated with the social networking information through a control panel of a user interface.

Continuing the ongoing example, content filtering module 110 filters content received from the music news website, the micro media feed of the musical group, and the online music service. Content filtering module 110 filters this content based on the interests of the user, interests of the user's contacts, and recommendations of other members of a social network in which the user in enrolled. Accordingly, the filtered content includes three subsets of filtered content: filtered content associated with the interests of the user, filtered content associated with interests of the user's social network contacts, and filtered content associated with recommendations of members of the social network.

Block 808 presents one of the multiple subsets of filtered content in a portion of a single user interface. This may include causing the presentation of the subset of filtered content via an API or other application layer. In some cases, the subset of filtered content selected from the multiple subsets of filtered content. In such cases, the one subset of filtered content can be selected by default or selected by a user (e.g., via a filtering control tab). Optionally, presentation of the subset of filtered content may be partitioned into sub-categories. These sub-categories may be based on various attributes associated with the filtered content, such as chronology, relevancy, proximity, popularity, and so on. For example, sub-categories may include breaking news, local news, sports, trending new, entertainment, and the like.

Concluding the present example, content filtering module 110 presents filtered content of the music news website, the micro media feed of the musical group, and the online music service in content presentation portion 302 as illustrated by FIG. 7. Here, the subset of filtered content associated with the interests of the user is presented as control tab 304 is currently selected. Additionally, as previously described, sub-categories of content 702-708 are defined for the video category 230. Here, filtered content associated with movies, TV series, and sports are presented in sub-categories 702, 704, and 706 respectively. Additionally, filtered content from the micro media feed of the musical group is presented in sub-category 708, along with filtered content from the online music service and/or music news website. Also, as described above, the user may also recommend content to other users via recommendation control 710 (one instance shown for visual clarity).

The preceding discussion describes methods relating to user-based content filtering. Aspects of these methods may be implemented in hardware (e.g., fixed logic circuitry), firmware, software, manual processing, or any combination thereof. A software implementation represents program code that performs specified tasks when executed by a computer processor. The example methods may be described in the general context of computer-executable instructions, which can include software, applications, routines, programs, objects, components, data structures, procedures, modules, functions, and the like. The program code can be stored in one or more computer-readable memory devices, both local and/or remote to a computer processor. The methods may also be practiced in a distributed computing mode by multiple computing devices. Further, the features described herein are platform-independent and can be implemented on a variety of computing platforms having a variety of processors.

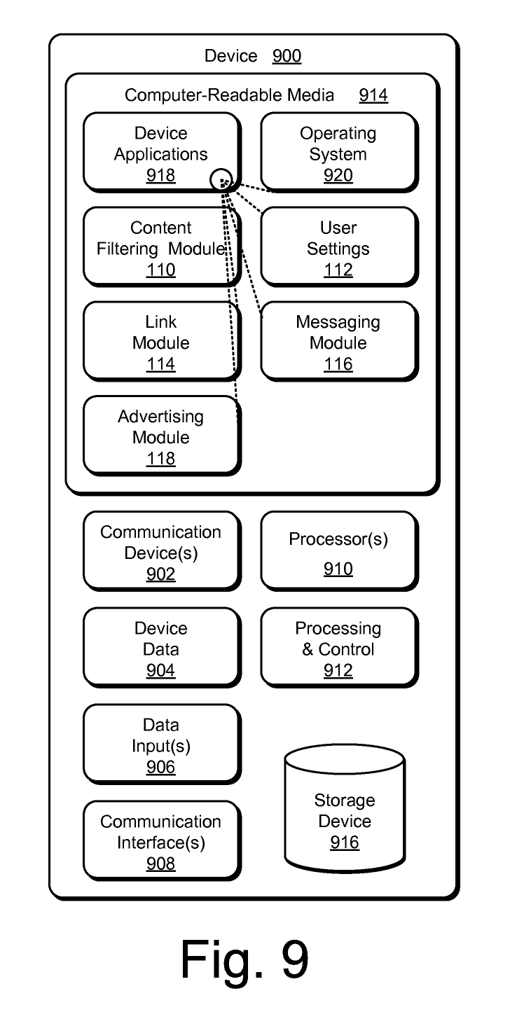

These techniques may be embodied on one or more of the entities shown in FIGS. 1 and 9 (device 900 is described below), which may be further divided, combined, and so on. Thus, these figures illustrate some of many possible systems or apparatuses capable of employing the described techniques. The entities of these figures generally represent software, firmware, hardware, whole devices or networks, or a combination thereof. In the case of a software implementation, for instance, the entities (e.g., content filtering module) represent program code that performs specified tasks when executed on a processor (e.g., processor(s) 106). The program code can be stored in one or more computer-readable memory devices, such as CRM 108 and/or computer-readable media 914 of FIG. 9.

Example Device

FIG. 9 illustrates various components of example device 900 that can be implemented as any type of computing device as described with reference to the previous FIGS. 1-8 to implement techniques of user-based content filtering. In some embodiments, device 900 can be implemented as one or a combination of a wired and/or wireless device, as a form of computing device (e.g., laptop computer, smart-phone, tablet computer, desktop computer, television set-top box, digital video recorder (DVR), etc.), consumer device, server device, portable computer device, communication device, video processing and/or rendering device, appliance device, gaming device, electronic device, System-on-Chip (SoC), and/or as another type of device or portion thereof. Device 900 may also be associated with a user (e.g., a person) and/or an entity that operates the device such that a device describes logical devices that include users, software, firmware, and/or a combination of devices.

Device 900 includes communication devices 902 that enable wired and/or wireless communication of device data 904 (e.g., received data, data that is being received, data scheduled for broadcast, data packets of the data, etc.). Device data 904 or other device content can include configuration settings of the device, media content stored on the device, and/or information associated with a user of the device. Media content stored on device 900 can include any type of audio, video, and/or image data. Device 900 includes one or more data inputs 906 via which any type of data, media content, and/or inputs can be received, such as human utterances, user-selectable inputs, messages, music, television media content, recorded video content, and any other type of audio, video, and/or image data received from any content and/or data source.

Device 900 also includes communication interfaces 908, which can be implemented as any one or more of a serial and/or parallel interface, a wireless interface, any type of network interface, a modem, and as any other type of communication interface. Communication interfaces 908 provide a connection and/or communication links between device 900 and a communication network by which other electronic, computing, and communication devices communicate data with device 900.

Device 900 includes one or more processors 910 (e.g., any of microprocessors, controllers, and the like), which process various computer-executable instructions to control the operation of device 900 and to perform user-based content filtering. Alternatively or in addition, device 900 can be implemented with any one or combination of hardware, firmware, or fixed logic circuitry that is implemented in connection with processing and control circuits, which are generally identified at 912. Although not shown, device 900 can include a system bus or data transfer system that couples the various components within the device. A system bus can include any one or combination of different bus structures, such as a memory bus or memory controller, crossbar, a peripheral bus, a universal serial bus, and/or a processor or local bus that utilizes any of a variety of bus architectures.

Device 900 also includes computer-readable storage media 914, such as one or more memory devices that enable persistent and/or non-transitory data storage (i.e., in contrast to mere signal transmission), examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 900 can also include a mass storage media device 916.

Computer-readable storage media 914 provides data storage mechanisms to store device data 904, as well as various device applications 918 and any other types of information and/or data related to operational aspects of device 900. For example, an operating system 920 can be maintained as a computer application with computer-readable storage media 914 and executed on processors 910. Device applications 918 may include a device manager, such as any form of a control application, software application, signal-processing and control module, code that is native to a particular device, a hardware abstraction layer for a particular device, and so on.

Device applications 918 also include any system components, engines, or modules to implement techniques enabling user-based content filtering. In this example, device applications 918 includes content filtering module 110 and user settings 112, link module 114, messaging module 116, and advertising module 118.

### CONCLUSION

Although embodiments of techniques and apparatuses enabling user-based content filtering have been described in language specific to features and/or methods, it is to be understood that the subject of the appended claims is not necessarily limited to the specific features or methods described. Rather, the specific features and methods are disclosed as example implementations enabling user-based content filtering.

What is claimed is:

1. A computer-implemented method comprising:
receiving, from a user, selection of a category of content to be presented;
determining, based on the selection of the category, one or more sources of content;
filtering, based on predefined settings for the user, content received from the one or more sources of content; and
presenting at least some of the filtered content in a portion of a single user interface, the portion of the single user interface associated with the category of content.

2. The computer-implemented method as described in claim 1, wherein the predefined settings for the user are associated with one or more social networks, the one or more social networks indicating interests or recommendations of content by members of the respective social networks.

3. The computer-implemented method as described in claim 1, wherein the filtering is based on interests of the user, interests of the user's contacts within the one or more social networks, or recommendations of other members of the one or more social networks.

4. The computer-implemented method as described in claim 1, wherein the single user interface includes visually-perceptible filtering controls, the visually-perceptible filtering controls including at least a filtering control associated with interests of the user, interests of the user's contacts, or the recommendations of other members of the one or more social networks.

5. The computer-implemented method as described in claim 4, further comprising receiving, from the user, selection of one of the visually-perceptible filtering controls, and wherein presenting at least some of the filtered content presents a subset of filtered content based on the selected visually-perceptible filtering control.

6. The computer-implemented method as described in claim 1, further comprising receiving, from the user, selection of one or more sub-categories for the category of content, and wherein the portion of the single user interface is visually partitioned based on the one or more selected sub-categories.

7. The computer-implemented method as described in claim 1, wherein the portion of the single user interface is configured to present multiple categories of content, and wherein the selection of the category of content is received via a visually-perceptible category control for one of the multiple categories of content, the visually-perceptible category control located external to the portion of the single user interface.

8. The computer-implemented method as described in claim 1, wherein the portion of the single user interface is a first portion, and the single user interface further includes a second portion presenting live feeds from a social network, a third portion presenting an advertisement, and a fourth portion enabling configuration of the predefined settings for the user.

9. A computer-implemented method comprising:
receiving, from a user, selection of one or more sources of content, the one or more sources of content providing content of a particular category;
receiving, from the one or more sources of content, the content of the particular category;
filtering, based on social networking information associated with the user, the received content to provide multiple subsets of filtered content; and
causing, via a portion of a single user interface, display of one of the multiple subsets of filtered content.

10. The computer-implemented method as described in claim 9, further comprising receiving, from the user, selection of the one of the multiple subsets of filtered content, and wherein the causing the display of the one of the multiple subsets of filtered content is responsive to receiving the selection of the one of the multiple types of filtered content.

11. The computer-implemented method as described in claim 9, wherein receiving the selection of the one or more sources of content comprises receiving a uniform resource locator (URL) for one of the sources of content.

12. The computer-implemented method as described in claim 9, further comprising receiving, from the user, selection of one or more sub-categories of content and wherein the display of the one of the multiple subsets of filtered content is visually partitioned based on the one or more selected sub-categories.

13. The computer-implemented method as described in claim 9, wherein the social networking information associated with the user includes interests of the user, interests of contacts with which the user is associated with by one or more social networks, or recommendations of other members of the one or more social networks.

14. The computer-implemented method as described in claim 9, wherein the particular category of content includes music, shopping, videos, photos, images, news, corporate information, travel, entertainment, or sports.

15. The computer-implemented method as described in claim 9, wherein the portion of the single user interface is a first portion, and further comprising causing display of, via a second portion of the single user interface, an online-status control, an advertisement, or feeds from one or more social networks with which the user is associated.

16. One or more computer-readable memory devices embodying instructions, that when executed by a processor, implement a content filtering module configured to:
receive, from a user, selection of one or more sources of content, the one or more sources of content providing content of a particular category;
receive, from the user, selection of one or more sub-categories for the particular category of content;
filter, based on social networking information associated with the user, the received content to provide multiple subsets of filtered content; and
cause, via a portion of a single user interface, display of one of the multiple subsets of filtered content, the portion of the single user interface visually partitioned based on the one or more selected sub-categories.

17. The one or more computer-readable memory devices as described in claim 16, wherein the one or more sub-categories are based on an age of the content, relevancy of the content, or a source from which the content is obtained.

18. The one or more computer-readable memory devices as described in claim 16, wherein the portion of the single user interface is a first portion configured to display the multiple subsets of the filtered content, and the single user interface further includes at least a second portion configured to display advertisements.

19. The one or more computer-readable memory devices as described in claim 18, wherein the content filtering module is further configured to register user interaction with the second portion of the single user interface and transmit an indication of the user interaction to an entity associated with the advertisements.

20. The one or more computer-readable memory devices as described in claim 16, wherein the one or more computer-readable memory devices are embodied in a smart-phone, tablet computer, laptop computer, set-top computing device, gaming device, or a desktop computer.
